(19) United States
(12) Patent Application Publication
(10) Pub. No.: US 2015/0347997 A1
(43) Pub. Date: Dec. 3, 2015

(54) PER-ITEM SECURITY CHECKS DURING SELF CHECKOUT PROCESSES

(71) Applicant: TOSHIBA GLOBAL COMMERCE SOLUTIONS HOLDINGS CORPORATION, Tokyo (JP)

(72) Inventors: Gregory Harris DELOTT, Durham, NC (US); Scott Andrew MARTIN, Chapel Hill, NC (US); Ankit SINGH, Morrisville, NC (US)

(73) Assignee: TOSHIBA GLOBAL COMMERCE SOLUTIONS HOLDINGS CORPORATION, Tokyo (JP)

(21) Appl. No.: 14/293,408

(22) Filed: Jun. 2, 2014

(51) Int. Cl. G06Q 20/18; G06Q 20/20

(52) U.S. Cl. CPC G06Q 20/18; G06Q 20/203; G06Q 20/208

(57) ABSTRACT

System, method, and computer program product to determine whether to apply a security check to items during a self-checkout process, by, responsive to receiving identification information for an item, generating a random number for the item, and upon determining that the random number exceeds a security value, applying the security check to the item.

### BACKGROUND

The present disclosure relates to computer software, and more specifically, to computer software to implement per-item security checks during self-checkout processes.

Retailers are exposed to greater risk of loss when customers, rather than retail employees, are allowed to process sales transactions in a retail store. Allowing customers to use self-checkout methods increases the risk of theft, as the retail employees are not present to process each item the customer may leave the store with. Retailers have implemented security checks that provide heightened security during these self-checkout processes. However, applying the security check to each item purchased by the customer is time consuming.

### SUMMARY

Embodiments disclosed herein include at least a system, method, and computer program product to determine whether to apply a security check to items during a self-checkout process, by, responsive to receiving identification information for an item, generating a random number for the item, and upon determining that the random number exceeds a security value, applying the security check to the item.

### BRIEF DESCRIPTION OF THE SEVERAL VIEWS OF THE DRAWINGS

FIGS. 1A-1B illustrate techniques to implement per-item security checks during self-checkout processes, according to one embodiment.

FIG. 2 illustrates a system to implement per-item security checks during self-checkout processes, according to one embodiment.

FIG. 3 is a flow chart illustrating a method to implement per-item security checks during self-checkout processes, according to one embodiment.

FIG. 4 illustrates a method to determine whether to apply security checks to each item selected for purchase, according to one embodiment.

### DETAILED DESCRIPTION

Embodiments disclosed herein randomly apply per-item security checks to items processed by a customer in a self-checkout customer transaction. Generally, a retailer may set a “security value” that equates to a percentage chance that any given item will be subject to a security check during the self-checkout process. For example, and without limitation, if the security value is 50 on a scale of 0 to 100, approximately 50% of the items may be subject to the security check. When the customer scans an item, embodiments disclosed herein generate a random number that is compared to the security value. If the random number is greater than the security value, the security check is applied to the item. If the random number is less than the security value, the security check is not applied to the item. Therefore, if the security value is 50, approximately 50% of the random numbers should be greater than the security value, and approximately 50% of the items may be subject to the security check.

In addition, different security values may be defined for different customer trust levels. For example, and without limitation, customer trust levels such as “low,” “medium,” “high,” and “complete” may be defined. The corresponding security values for each customer trust level may be 100, 80, 40, and 0, respectively. Therefore, for customers having a “low” trust level, the retailer may apply security checks on each item processed by the customer, while security checks may not be applied on any items processed by customers having a “complete” trust level. Likewise, 40% and 80% of the items processed by customers having “high” and “medium” trust levels, respectively, will have security checks applied when the customer processes the item for purchase.

Generally, the disclosure may be applied to any customer-driven self-checkout system. Examples of such self-checkout systems include, without limitation, self-checkout kiosks and mobile devices executing point-of-sale applications allowing customers to “scan” items and pay for their selected items. Furthermore, any technique may be used to “scan” or identify items, such as reading a barcode or quick response (QR) code on an item, reading a radio frequency identification (RFID) tag on (or in) the item, or analyzing a captured image of the item to identify the item. Further still, a user may manually type in a code or other unique identifier of the product using a physical or virtual keyboard.

Generally, the security checks may be any type of security check. For example, when a customer uses a self-checkout kiosk, the kiosk may weigh the “scanned” item to determine whether the item weight falls within a predefined range of weights for the item. Similarly, other dimensions of the item may be compared against a range of known values as part of the security check, such as item height, width, and depth. Further still, images of the item may be captured (using, for example, in-store security cameras or a camera on the customer's mobile device) and compared to known images of the item to ensure that the correct item was scanned. Whenever one of these security checks fails, the self-checkout applications may perform any number of operations in response. For example, a warning may be issued to the customer, or a notification may appear on a system owned by the retailer indicating that an employee should investigate the customer's self-checkout transaction. Therefore, if the customer scans what purports to be a one pound box of cereal, but the item in fact weighs ten pounds, the security check can identify the excess weight, and notify an employee of the retail store.

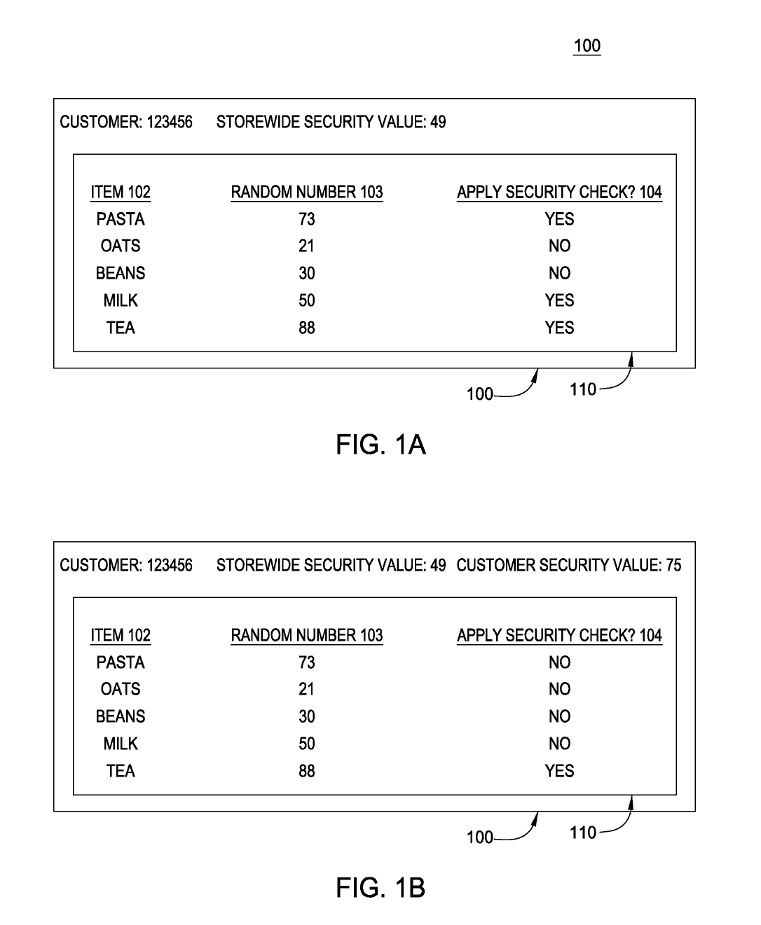

FIG. 1A illustrates techniques to implement per-item security checks during self-checkout processes, according to one embodiment. Generally, FIG. 1A depicts a display 100 that includes transaction log 110 including an entry for each item scanned by a customer performing a self-checkout operation in a retail store. The transaction log 110 includes a column of items 102 scanned by the customer, a random number 103 generated responsive to each item scan, and a column 104 indicating whether a security check will be applied to the item. Therefore, the transaction log 110 may reflect the results of a self-checkout kiosk, mobile scanning application, and the like, where a customer scans (or otherwise identifies) products for purchase, and the system determines whether to apply the security check for each item. When the random number 103 is greater than the security value, the system applies the security check for the item.

As shown in the display 110, a “storewide security value” of 49 (on a scale from 0-100) has been defined. In some embodiments, the storewide security value is defined by a user (e.g., a store manager). By selecting 49 as the storewide security value, approximately half of the items scanned by all customers in the store may be subject to the security checks, as over time, approximately 50% of the random numbers generated (on the scale from 0-100) for each item should be greater than the storewide security value of 49. As shown, therefore, when a customer scans an item 102, the computing system (such as a self-checkout kiosk or mobile application, both not shown) may generate a corresponding random number 103. If the random number 103 for the item 102 is greater than the storewide security value, then the system may apply the security check to the item 102. For example, the random number 103 generated for pasta was 73. Since 73 is greater than 49, the system may apply a security check to the pasta. For example, the system may direct the customer to place the pasta on a scale, which weighs the pasta to ensure that it is within a predefined weight range for the pasta. As another example, the random number 103 generated for the beans was 30. Because 30 is less than 49, the system does not apply the security check to the beans.

FIG. 1B illustrates techniques to implement per-item security checks during self-checkout processes, according to one embodiment. Generally, FIG. 1B depicts an embodiment where customer-specific security values are used in determining whether to apply a security check to items scanned by a customer during a self-checkout operation. As shown, the display 100 now reflects a customer security value of 75 for customer 123456. The customer security value may be associated with the customer's frequent shopper account, for example. Because the retailer has a greater level of trust in customer 123456, the retailer has decided to apply a security check to approximately 25% of the items scanned by customer 123456, as the security value is 75. The customer security value may be specific to the customer, or may be a security value that is assigned to a class of customers in which the retailer has a heightened level of trust. Therefore, the transaction log 111 shows the results of the same items 102 and random numbers 103 generated in FIG. 1A. However, the transaction log 111 reflects a determination to apply the security check 104 based on the customer security value of 75. As shown, therefore, of the random numbers 103, only the tea has a random number 103 that is greater than 75. As such, the tea is the only item that the system will apply the security checks to, as reflected in column 104. Unlike in FIG. 1A, the security checks will not be applied to the pasta and milk, as their corresponding random numbers are not greater than the customer security value of 75.

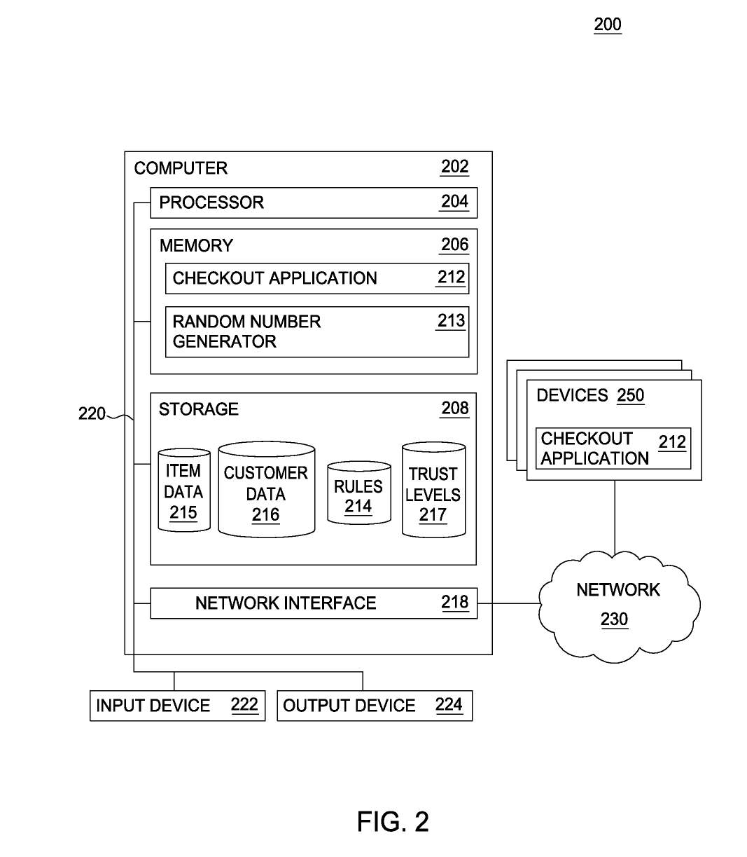

FIG. 2 illustrates a system 200 to implement per-item security checks during self-checkout processes, according to one embodiment. The networked system 200 includes a computer 202. The computer 202 may also be connected to other computers, such as the devices 250 via a network 230. In at least one embodiment, the computer 202 is part of a self-checkout kiosk. In other embodiments, the computer 202 may be a mobile device executing an application allowing customers to complete sales transactions using the mobile device. Likewise, the devices 250 may be self-checkout computers, kiosks, mobile device, or any device configured to process self-checkout transactions. In general, the network 230 may be a telecommunications network and/or a wide area network (WAN). In a particular embodiment, the network 230 is the Internet. In another embodiment, the network 230 is a local area network (LAN).

The computer 202 generally includes a processor 204 connected via a bus 220 to a memory 206, a network interface device 218, a storage 208, an input device 222, and an output device 224. The computer 202 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 204 is included to be representative of a single CPU, multiple CPUs, a single CPU having multiple processing cores, and the like. The network interface device 218 may be any type of network communications device allowing the computer 202 to communicate with other computers via the network 230.

The storage 208 may be a persistent storage device. Although the storage 208 is shown as a single unit, the storage 208 may be a combination of fixed and/or removable storage devices, such as fixed disc drives, solid state drives, SAN storage, NAS storage, removable memory cards or optical storage. The memory 206 and the storage 208 may be part of one virtual address space spanning multiple primary and secondary storage devices.

The input device 222 may be any device for providing input to the computer 202. For example, a keyboard and/or a mouse may be used. The output device 224 may be any device for providing output to a user of the computer 202. For example, the output device 224 may be any conventional display screen or set of speakers. Although shown separately from the input device 222, the output device 224 and input device 222 may be combined. For example, a display screen with an integrated touch-screen may be used.

As shown, the memory 206 includes the checkout application 212 and the random number generator 213. The checkout application 212 is an application generally configured to process customer transactions as part of a self-checkout operation. Generally, the checkout application 212 may receive an identifier from an item a customer has selected for purchase, and use the identifier to add the item to the customer's order. For example, the customer may scan a bar code or QR code on an item, and the checkout application 212 may add the relevant attributes of the item to the order, such as price and tax information. When the customer is finished scanning items, the checkout application 212 may compute a total transaction cost (including applicable sales taxes), and may receive payment from the customer in order to complete the transaction.

The checkout application 212 may be further configured to impose security checks on items selected for purchase by customers. Generally, the checkout application 212 may reference one or more rules in the rules 214 regarding security policies, and apply the rules to the items selected by customers. The checkout application 212 is further configured to impose these security checks on a per-item basis based on a security value. Generally, the security value may be any value in a predefined range of values. For example, the range may be 0-10, 0-100, 0-1000, A-Z, and the like. The security value may be a default security value, or may be tailored to specific customers or groups of customers. For example, the default security value may be 40 on a scale from 0-100. However, different customers or groups of customers may have different security values based on their respective levels of trust. When a customer scans a product, the checkout application 212 may invoke the random number generator 213 in order to receive a random number for the product. The checkout application 212 may then compare the random number for the product to the relevant security value. If the random number generator 213 returns a value greater than the security value, the checkout application 212 may impose the security check on the scanned product. If the random number generator 213 returns a random number smaller than the security value, the checkout application 212 does not apply the security check to the product. For example, if the random number generator 213 returns a 99 for a first product when the security value is 40, the checkout application 212 will impose a security check on the first product. If the random number generator 213 returns a 10 as the random number for a second product, the checkout application 212 will not impose the security check on the second product, as the random number is less than the security value.

Generally, the checkout application 212 may apply any comparison logic to compare the random number to the security value in order to determine whether to apply security checks to a given item. For example, and without limitation, the checkout application 212 may apply the security check if the random number is greater than, less than, greater than or equal to, less than or equal to, or equal to the security value. A user, such as a store manager or system administrator, may select the security value and comparison logic used in each implementation.

The random number generator 213 is an application generally configured to generate a sequence of numbers or symbols that lack a pattern. In at least one embodiment, the checkout application 212 incorporates the functionality of the random number generator 213.

As shown, the storage 208 includes a rules store 214, an item data store 215, a customer data store 216, and a trust levels store 217. The rules stored in the rules 214 may include security checks that should be applied to one or more products in the item data 215. For example, a first rule 214 may specify that a weight of the product received from a scale attached to the computer 202 must be within a known weight range of the product stored in the item data 215. Generally, any type of security policy may be stored in the rules 214. In addition, the default security value may be stored in the rules 214. The item data 215 includes a plurality of attributes for different items offered for sale. For example, product weights, sizes, prices, and the like may be defined in the item data 215. The customer data 216 may include customer attributes and metadata, such as customer loyalty data, names, addresses, and the like. Additionally, one or more customer records in the customer data 216 may include a customer-specific security value used by the checkout application 212 to determine whether to apply security checks. Generally, retailers may define customer-specific security values to impact the percentage of products that are subject to security checks. For example, if a retailer knows that a customer has previously stolen from the retailer, the customer's security value may be zero, or any value sufficient to cause the checkout application 212 to apply security checks to every item scanned by the customer. The checkout application 212 may modify the customer-specific security value over time based on any number of factors. For example, if the customer's spending level increases, or a predefined amount of time without an attempted theft that has passed, the checkout application 212 may modify the customer-specific security value accordingly. Likewise, if a previously trusted customer is caught stealing, the checkout application 212 may modify the customer-specific security value to reflect less trust in the customer.

The customer metadata in the customer data 216 may also specify one of the trust levels 217. The trust levels 217 may include a plurality of different “categories” of trust, such as low, medium, or high. Each trust level in the trust levels 217 may correspond to a respective security value. For example, the low, medium, and high trust levels 217 may have security values of 33, 66, and 99, respectively, on a scale from 0-100. The security values may be defined by a user, or the checkout application 212. In such cases, the checkout application 212 may use these security values when processing a transaction of a customer that is a member of one of these trust levels 217.

The devices 250, in some embodiments, may be mobile devices such as smart phones, tablet computers, portable computers, and mobile scanning devices. The devices 250, as shown, include an instance of the checkout application 212. In such embodiments, the checkout application 212 may communicate with the computer 202 using a network connection (not shown). In some embodiments, the devices 250 may include local copies of the rules store 214, the item data store 215, the customer data store 216, and the trust levels store 217.

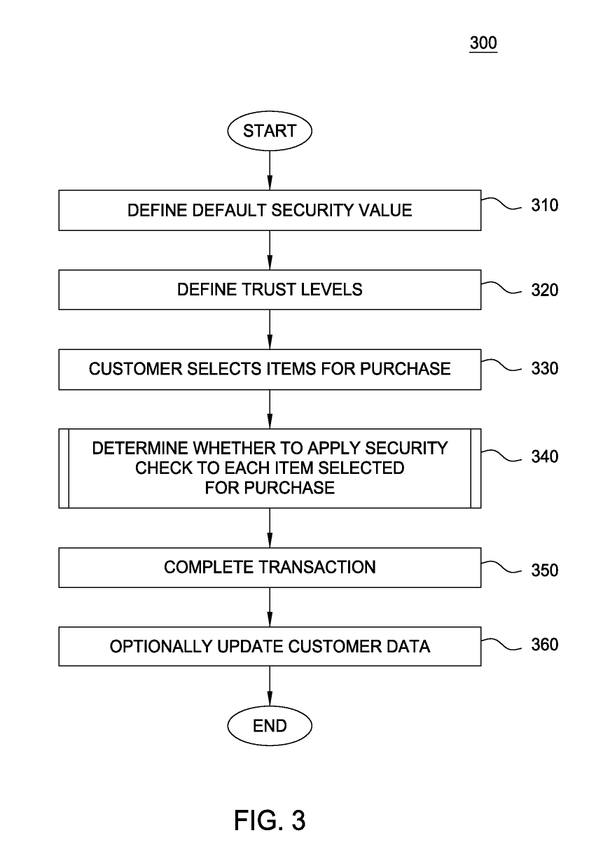

FIG. 3 is a flow chart illustrating a method 300 to implement per-item security checks during self-checkout processes, according to one embodiment. At step 310, a user or the checkout application 212 defines a default (or store-wide) security value that serves as the default security value for a retailer or store. In the absence of a more specific security value, such as a customer-specific security value, or a class-specific security value through membership in one of the trust levels 217, the checkout application 212 may apply the default security value in order to determine whether to apply security checks. At step 320, a user or the checkout application 212 may optionally define the trust levels 217, including a class-specific security value for each trust level in the trust levels 217.

At step 330, a customer selects an item for purchase. Generally, at step 330, the customer passes an identifier of a product to the checkout application 212. For example, and without limitation, the identifier may be a bar code, QR code, RFID data, or an image of the product. Any suitable method may be used to identify a product. At step 340, the checkout application 212 determines whether to apply one or more security checks to the item selected by the customer at step 330 by comparing a random number generated for the item to the relevant security value. If the random number is greater than the security value, the checkout application 212 may apply the security check to the product. The type of security check may be based on the type of item. For example, some objects (such as fruits and vegetables) may be visually detected. At step 350, the customer may complete the sales transaction. At step 360, the checkout application 212 may optionally update the customer data for the customer completing the sales transaction. For example, if the customer's spending habits reach new high dollar values, the checkout application 212 may raise the customer-specific trust value in customer's profile in the customer data 216.

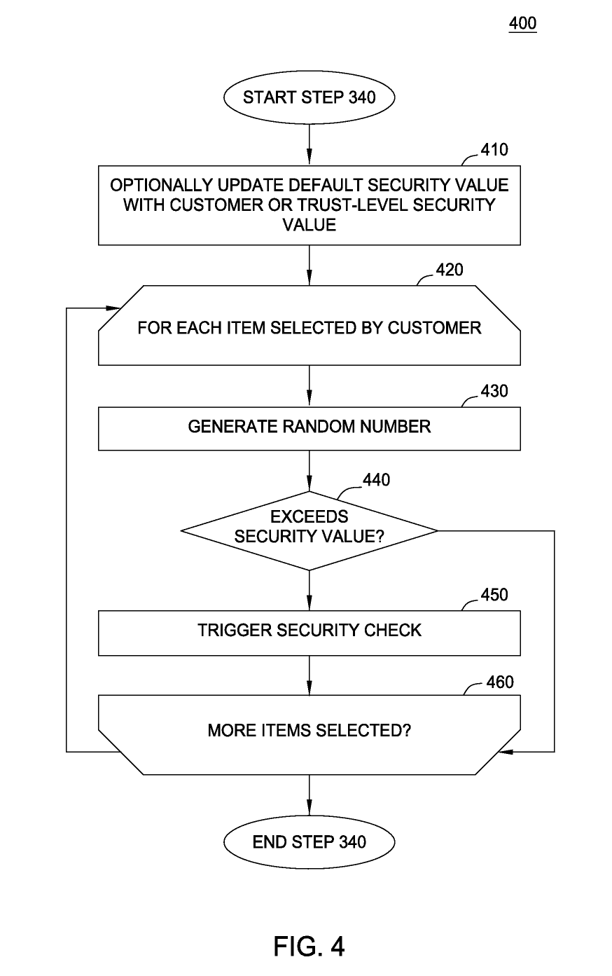

FIG. 4 illustrates a method 400 to determine whether to apply security checks to each item selected for purchase, according to one embodiment. Generally, the checkout application 212 may compare a random number generated for each product to the relevant security value in order to determine whether to apply the security checks. At step 410, the checkout application 212 may override the default security value with a customer-specific security value in the customer data 216. In the absence of a customer-specific security value, the checkout application 212 may use a trust-level security value if the customer is associated with one of the trust levels 217. The user may, for example, scan a loyalty card, enter a phone number, or any other identifier sufficient to allow the checkout application 212 to access the customer's information in the customer data 216, and identify customer-specific or trust-level specific security values. If the customer has a customer-specific trust level and belongs to a trust level 217, the checkout application 212 may choose between either as the relevant security value. If the customer does not enter identification information, the checkout application 212 may proceed using the default security value.

At step 420, the checkout application 212 begins executing a loop including steps 430-460 for each item selected for purchase by the customer. At step 430, the checkout application 212 (or the random number generator 213) may generate a random number for the current item. A step 440, the checkout application 212 determines whether the random number is greater than the security value. If the random number is not greater than the security value, the checkout application 212 does not apply a security check to the item, and proceeds to step 460. If the random number is greater than the security value, the checkout application 212 proceeds to step 450, where a security check is triggered. For example, the checkout application 212 may ensure that the item's packaging dimensions are within a specified set of known dimensions in the item data 215. Generally, the checkout application 212 may apply any security check, such as calling a store employee for assistance, comparing weights, and performing image analysis to verify the item.

At step 460, the checkout application 212 determines whether the customer has selected additional items for purchase. If the customer “scans” or otherwise inputs identification information for additional items, the checkout application 212 may return to step 420. Otherwise, the method 400 ends.

Advantageously, embodiments disclosed herein may reduce the amount of time a customer needs to complete a self-checkout operation by limiting a percentage of the items that are subject to security checks. By randomizing the screening process, customers may be more trustworthy, as they will not know which items are subject to security checks. Generally, each time a customer “scans” a product for purchase, embodiments disclosed herein generate a random value, which is compared to a security value. If the random value exceeds the security value, the item is subject to a security check.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications or related data available in the cloud. For example, the checkout application 212 could execute on a computing system in the cloud and impose per-item security checks on items selected for purchase by customers as part of a self-checkout process. In such a case, the checkout application 212 could process the transactions and store customer-specific trust values at a storage location in the cloud. Doing so allows a user to access this information from any computing system attached to a network connected to the cloud (e.g., the Internet).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method to determine whether to apply a security check to items during a self-checkout process, comprising:
responsive to receiving identification information for an item and by operation of one or more computer processors:
generating a random number for the item; and
upon determining that the random number exceeds a security value, applying the security check to the item, wherein the security value specifies a likelihood of applying the security check to items during the self-checkout process.

2. The method of claim 1, wherein identification information for a plurality of items is received during the self-checkout process, wherein a respective random number is generated responsive to receiving the identification for each item, wherein the security check is applied to each item having a respective random number that exceeds the security value.

3. The method of claim 2, wherein the security value is a predefined value applied to each self-checkout process in a retail store, wherein the security value and the random number are within a range of common values.

4. The method of claim 3, wherein a maximum security value causes the application of the security check to each item, wherein a minimum security value causes the application of the security check to none of the items.

5. The method of claim 1, wherein the security value is based on a trust level of a customer performing the self-checkout process, wherein a plurality of security values and trust levels are defined, wherein each of the plurality of security values corresponds to a respective trust level.

6. The method of claim 1, wherein the security check comprises at least one of: (i) comparing a weight of the item to a predefined range of acceptable weights for the item, (ii) comparing a height of the item to a predefined range of acceptable heights for the item, and (iii) capturing an image of the item to determine whether the image of the item matches a stored image of the item.

7. The method of claim 1, wherein the identification information comprises at least one of: (i) a unique identifier of the item and (ii) an image of the item, wherein a customer performs the self-checkout process using a self-checkout application, wherein the self-checkout application executes on at least one device comprising: (i) a self-checkout kiosk, (ii) a mobile device of the customer, and (iii) a mobile checkout device provided by a retailer.

8. A system, comprising:
one or more computer processors; and
a memory containing a program, which when executed by the one or more processors, performs an operation to determine whether to apply a security check to items during a self-checkout process, the operation comprising:
responsive to receiving identification information for an item:
generating a random number for the item; and
upon determining that the random number exceeds a security value,
applying the security check to the item, wherein the security value specifies a likelihood of applying the security check to items during the self-checkout process.

9. The system of claim 8, wherein identification information for a plurality of items is received during the self-checkout process, wherein a respective random number is generated responsive to receiving the identification for each item, wherein the security check is applied to each item having a respective random number that exceeds the security value.

10. The system of claim 9, wherein the security value is a predefined value applied to each self-checkout process in a retail store, wherein the security value and the random number are within a range of common values.

11. The system of claim 10, wherein a maximum security value causes the application of the security check to each item, wherein a minimum security value causes the application of the security check to none of the items.

12. The system of claim 8, wherein the security value is based on a trust level of a customer performing the self-checkout process, wherein a plurality of security values and trust levels are defined, wherein each of the plurality of security values corresponds to a respective trust level.

13. The system of claim 8, wherein the security check comprises at least one of: (i) comparing a weight of the item to a predefined range of acceptable weights for the item, (ii) comparing a height of the item to a predefined range of acceptable heights for the item, and (iii) capturing an image of the item to determine whether the image of the item matches a stored image of the item.

14. The system of claim 8, wherein the identification information comprises at least one of: (i) a unique identifier of the item and (ii) an image of the item, wherein a customer performs the self-checkout process using a self-checkout application, wherein the self-checkout application executes on at least one device comprising: (i) a self-checkout kiosk, (ii) a mobile device of the customer, and (iii) a mobile checkout device provided by a retailer.

15. A computer program product to determine whether to apply a security check to items during a self-checkout process, comprising:
a computer-readable storage medium having computer-readable program code embodied therewith, the computer-readable program code comprising:
computer-readable program code configured to, responsive to receiving identification information for an item:
generate a random number for the item; and
upon determining that the random number exceeds a security value, apply the security check to the item, wherein the security value specifies a likelihood of applying the security check to items during the self-checkout process.

16. The computer program product of claim 15, wherein identification information for a plurality of items is received during the self-checkout process, wherein a respective random number is generated responsive to receiving the identification for each item, wherein the security check is applied to each item having a respective random number that exceeds the security value.

17. The computer program product of claim 16, wherein the security value is a predefined value applied to each self-checkout process in a retail store, wherein the security value and the random number are within a range of common values.

18. The computer program product of claim 17, wherein a maximum security value causes the application of the security check to each item, wherein a minimum security value causes the application of the security check to none of the items.

19. The computer program product of claim 18, wherein the security value is based on a trust level of a customer performing the self-checkout process, wherein a plurality of security values and trust levels are defined, wherein each of the plurality of security values corresponds to a respective trust level.

20. The computer program product of claim 15, wherein the security check comprises at least one of: (i) comparing a weight of the item to a predefined range of acceptable weights for the item, (ii) comparing a height of the item to a predefined range of acceptable heights for the item, and (iii) capturing an image of the item to determine whether the image of the item matches a stored image of the item, wherein the identification information comprises at least one of: (i) a unique identifier of the item and (ii) an image of the item, wherein a customer performs the self-checkout process using a self-checkout application, wherein the self-checkout application executes on at least one device comprising: (i) a self-checkout kiosk, (ii) a mobile device of the customer, and (iii) a mobile checkout device provided by a retailer.
